(19) United States
(12) Patent Application Publication
(10) Pub. No.: US 2025/0342736 A1
(43) Pub. Date: Nov. 6, 2025

(54) SYSTEMS, METHODS, AND DEVICES FOR HANDS-FREE ENTRYWAYS

(71) Applicant: Masonite Corporation, Tampa, FL (US)

(72) Inventors: Navid Andalibi-Abadan, Naperville, IL (US); Jason M. Walsh, Batavia, IL (US); Sammie Nesslein, Tampa, FL (US); Satishkumar Sivasankaran, Aurora, IL (US); Andrea Moncada, Berwyn, IL (US); Marial Bolando, Tampa, FL (US); Heather Evans, Tampa, FL (US)

(21) Appl. No.: 19/197,447

(22) Filed: May 2, 2025

Related U.S. Application Data
(60) Provisional application No. 63/642,177, filed on May 3, 2024.

(51) Int. Cl. G07C 9/00

(52) U.S. Cl. CPC G07C 9/00182; G07C 9/00563; G07C 9/00571; G07C 9/00944

(57) ABSTRACT

The present disclosure provides a system for a hands-free entryway, comprising at least one sensor configured to sense a user approaching an entryway with a pivotally attached door. A latch disengaging mechanism positioned in a jamb or frame of the entryway is controlled by a controller operatively associated with a processor. The controller determines whether to activate the latch disengaging mechanism to automatically unlatch the door based on sensor data. A user feedback component indicates to the user that the entryway can be used without requiring hands to unlatch it. An entryway closing device is configured to bias the door to a closed state. The system enables hands-free operation of the entryway while providing user feedback and automatic closing functionality.

### CROSS-REFERENCE TO RELATED APPLICATIONS

This application claims the benefit of U.S. Application No. 63/642,177, filed May 3, 2024, the contents of which are incorporated by reference herein in their entirety.

### FIELD

The present technology is directed to entryways, e.g., exterior, entryway from garage bays or other, e.g., interior doors, for residential or commercial buildings, such as for a home, apartment, condominium, hotel room or business, and in exemplary embodiments to systems, methods and devices for hands-free entryways that provide for a user to open the door hands-free, e.g., if a user's hands are full or not readily available to unlatch the entryway.

### BACKGROUND

Typical existing entryways require users to use their hands to pass through an entryway, e.g., an exterior door having a latch handle. This can be difficult when a user is encumbered or otherwise unable or less able to use their hands for entry.

For example, a user could be entering into the home from a garage (or through another exterior door), bringing in groceries, packages, their children, pets, etc. When their hands are occupied, they have to awkwardly try to open the door with their hands full, or place whatever they are carrying down to first open the door and then walk through.

In other examples, a homeowner or other party may wish to enter the house with dirty hands, e.g., from automotive work, yard work, or the like, and wish to pass through the door without touching any parts of the door and leaving marks.

In still further examples, a user may not otherwise be able or may be less able to use one or both hands, e.g., if the user has a disability of some sort, be in a wheelchair, etc.

What is needed in the art are systems, methods, and devices for hands-free entryways. What is further needed in the art are cost efficient and effective systems, methods, and devices for such hands-free entryways suitable for residential installations and use.

### SUMMARY

The present disclosure advantageously provides for systems, methods and devices for hands-free entryways that includes at least one sensor configured to sense a user that is approaching an entryway, a latch disengaging mechanism, and a user feedback component that indicates to a user that the entryway can be used without requiring hands to unlatch a door.

In exemplary aspects, the at least one sensor detects any person approaching the entryway, e.g., as a motion sensor, voice sensor, video sensor, mobile phone proximity sensor, ultra wide-band signal sensor, RFID tag, biometric sensor and/or camera configured with a pre-defined or user-definable sensing area. The sensor may be configured to detect at a predetermined height and distance relative to the entryway. In further exemplary embodiments, such sensor(s) are configured to infer a user's intent to enter through the entryway. The at least one sensor may be positioned within at least one of a door, jamb and/or frame of the entryway.

In other exemplary embodiments, the at least one sensor is configured to authenticate a user using one or more authentication methods from among a biometric identification method, a mobile device authentication method and a behavioral analysis method. The biometric identification methods may include one or more of facial recognition with 3D depth mapping, voice pattern analysis, fingerprint scanning, or iris recognition.

In further exemplary embodiments, the at least one sensor comprises two or more different types of sensors, wherein each of the two or more different types of sensors senses a different type of authentication data, and wherein the processor is configured to integrate the different types of authentication data through a weighted algorithm to enforce specific entry conditions for different user types. A management interface may be provided to receive input from an administrator for establishing the specific entry conditions for the different user types.

Additionally, any of identification, authentication, and authorization for a particular user, if such is implemented, may be local, at the edge of the cloud or within the cloud, in various exemplary embodiments, or may be a part of user or administrator settings to configure such.

In further exemplary aspects, the latch disengaging mechanism comprises an electric strike mechanism positioned within the jamb or frame of the entryway. The entryway closing device may comprise at least one of a spring hinge, a pneumatic closer, a hydraulic closer, a rack-and-pinion closer, and an electric motor-driven closer. In further exemplary embodiments, a combination of one or more latch retraction devices and/or electric strikes may be used. In exemplary aspects, this may also be combined with a door actuator, as is known in the art.

In exemplary aspects, the user feedback component comprises one or more of a sound indicator and a light source. The light source may be positioned within the jamb or frame of the entryway that indicates, by emitting a light of a particular color, whether the entryway is operable for passage therethrough without requiring the user to manually unlatch the entryway.

Additionally, in other exemplary aspects, a battery module can be separate from the user interface module and positioned in the jamb or frame of the entryway. Alternatively, a combined user interface module and battery module may be positioned within the jamb or frame of the entryway, wherein the combined user interface module and battery module houses both a power source and the user feedback component in a single housing.

Other exemplary user feedback mechanisms (indicating that the door is unlatched or to otherwise provide the status of the entryway, at least during such indication), include but are not limited to sound, moving of the door, communication with user devices, other feedback, etc.

In further exemplary aspects, a programmed flow can be used, which may be pre-set, user-set or administrator-set (including user or administrator configurable as well), which can also include timings (which term also includes periodic checks over time), e.g., for the time for powering of an electric strike to the time for deactivating the power to the strike, time to actuate a door (if actuator elements are present for opening and/or closing, or even bumping a door, are present), times to notify a user of door status, whether by visual indicators, sound indicators, user device indicators, etc., times to check battery or other status metrics, times to check or recheck the status of deadbolts (even as it relates to partial deployment of such deadbolts), etc.

In further exemplary aspects, the entryway comprises a locking mechanism that includes a deadbolt, and the sensor data includes deadbolt sensor status data relating to non-deployment or at least partial deployment of the deadbolt. A deadbolt sensor that detects one or both of a deadbolt locked condition or partial deployment of a deadbolt triggers a processor routine (e.g., at a controller) that indicates that the entryway is not accessible and either does not emit a light, sound or other indication in accordance with such, or that provides indication that the door is not ready for entry to the user (using any available mechanism for the user). If there is a door actuator and/or door strike, this would also override open control signals for those aspects.

In other exemplary aspects, the door system or aspects thereof are not triggered or enabled until certain events present, e.g., a garage door opens, a certain vehicle enters, a person with a particular identifier approaches, a user (or one of plural users) is authenticated and authorized, etc.

In further exemplary aspects, the system is configured to infer whether the user is exiting from the interior or entering from the exterior using one or more sensors (and/or the lack of a signal from one or more sensors) and to make control decisions regarding activating the electric strike or other latch mechanism to allow for hands-free entry.

In other exemplary aspects, a sensor monitors the exterior (or interior) environment, e.g., measuring temperature; and the system is configured to not allow for hands-free entry if the temperature is outside of a predetermined or configurable range.

In further exemplary aspects, hands-free entry is facilitated by use of a latching doorknob including: a doorknob motor; doorknob circuitry electrically coupled to the doorknob motor and configured to be remotely connected to the remote computing device; a power transmission assembly coupled to the doorknob motor and configured to translate a rotational movement of the doorknob motor to a linear movement of a latch mechanism responsive to receipt of the signal.

In additional exemplary aspects, the latch mechanism may include a latch with a first end and a second end, and a latch housing with a hollow central portion and a first end formed by a plate with an aperture connected to the hollow central portion; wherein the power transmission assembly is coupled to the second end of the latch; wherein in response to the receipt of the signal, the power transmission assembly is configured to horizontally translate the latch within the hollow central portion of the latch housing and the first end of the latch is positioned within the aperture of the plate or within the hollow central portion of the latch housing; and wherein the latch mechanism is configured to be coupled to a first doorknob and a second doorknob.

In other exemplary aspects, the apparatus may include a first doorknob; a second doorknob; a latch mechanism coupling the first doorknob and the second doorknob; a doorknob motor; doorknob circuitry electrically coupled to the doorknob motor and configured to be in communication with a remote computing device, wherein the doorknob motor is configured to be remotely activated by the remote computing device responsive to receipt of a signal; and a power transmission assembly coupled to the doorknob motor and configured to translate a rotational movement of the doorknob motor responsive to receipt of the signal to a linear movement of the latch mechanism; the apparatus configured to be coupled to a door, with the first doorknob positioned on an interior side or exterior side of the door, and the second doorknob positioned on the other of the interior side or exterior side of the door, and the latch mechanism extending through a portion of the door between the interior side and exterior side of the door.

In further exemplary aspects, the power transmission assembly may further include a driver gear coupled to the doorknob motor and a gear rack coupled to the latch mechanism.

In additional exemplary aspects, the latch mechanism may include a latch with a first end and a second end, and a latch housing with a hollow central portion and a first end formed by a plate with an aperture connected to the hollow central portion; wherein the power transmission assembly is coupled to the second end of the latch; wherein in response to the receipt of the signal, the power transmission assembly is configured to horizontally translate the latch within the hollow central portion of the latch housing and the first end of the latch is positioned within the aperture of the plate or within the hollow central portion of the latch housing.

In further exemplary aspects, the latch mechanism may be configured to be coupled to a first doorknob and a second doorknob.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1A is a perspective view of an exemplary entryway system illustrating an exemplary sensor, door, and frame, according to exemplary embodiments provided herein;

FIG. 1B is a perspective view of the exemplary entryway system illustrated in FIG. 1A, wherein the latch is disengaged and the door is slightly ajar, according to exemplary embodiments provided herein;

FIG. 1C is a perspective view of the exemplary entryway system illustrated in FIG. 1A, wherein the latch is disengaged and the door is bumped or pushed open, according to exemplary embodiments provided herein;

FIG. 2 illustrates a deconstructed perspective view of a frame/jamb construction including exemplary elements of the present hands-free system, in accordance with embodiments of the present disclosure;

FIG. 3A is a close-up perspective view of an exemplary door and frame/jamb hands-free system in accordance with embodiments of the present disclosure;

FIG. 3B is a perspective view of an exemplary integrated strike plate, which may be used in lieu of the separated strike and deadbolt and ball detent plate shown in FIG. 3A, in accordance with embodiments of the present disclosure;

FIG. 3C is a front elevation view of an exemplary spring hinge, which may be used to return the door to a closed state in accordance with embodiments of the present disclosure;

FIG. 3D is a perspective view of installation of an exemplary fire-retardant material over a component provided in a milled out or cut out frame area, in accordance with embodiments of the present disclosure;

FIG. 3E is an exemplary system architecture schematic, in accordance with embodiments of the present disclosure;

FIG. 4A is a top perspective view of an exemplary user interface module, in accordance with embodiments of the present disclosure;

FIG. 4B is a side elevation view of the exemplary user interface of FIG. 4A;

FIG. 5A is a bottom perspective view of a jamb including a sensor component, in accordance with embodiments of the present disclosure;

FIG. 5B is a front elevation view of a module backing plate, in accordance with embodiments of the present disclosure;

FIG. 5C is a perspective view of a module, with alignment pins, in accordance with embodiments of the present disclosure;

FIG. 5D is a perspective view of the interior of a module with magnets, in accordance with embodiments of the present disclosure;

FIG. 5E is a side plan view of an installed module, with magnets holding against a backing plate, in accordance with embodiments of the present disclosure;

FIG. 6A is a schematic of an exemplary system flow for a hands-free system, in accordance with embodiments of the present disclosure;

FIG. 6B is another schematic of an exemplary system flow for a hands-free system, in accordance with embodiments of the present disclosure;

FIG. 6C is an exemplary processing flowchart for another exemplary mode of operation, in accordance with embodiments of the present disclosure;

FIG. 6D shows an exemplary system logic, in accordance with embodiments of the present disclosure;

FIG. 7A is a block diagram of an exemplary spring-based deadbolt sensor in accordance with embodiments of the present disclosure;

FIG. 7B is another block diagram of an exemplary spring-based deadbolt sensor in accordance with embodiments of the present disclosure;

FIG. 7C is a block diagram of an exemplary spring-based deadbolt sensor in accordance with embodiments of the present disclosure;

FIG. 7D is a block diagram of an exemplary ultrasonic or other time of flight deadbolt sensor in accordance with embodiments of the present disclosure;

FIG. 7E is a block diagram of another exemplary ultrasonic or other time of flight deadbolt sensor in accordance with embodiments of the present disclosure;

FIG. 7F is a block diagram of an exemplary stop switch deadbolt sensor in accordance with embodiments of the present disclosure;

FIG. 7G is a block diagram of an exemplary photo-eye line of sight deadbolt sensor in accordance with embodiments of the present disclosure;

FIG. 7H is a block diagram of an exemplary capacitive/non-contact deadbolt sensor in accordance with embodiments of the present disclosure;

FIG. 7I is a block diagram of another exemplary capacitive/non-contact deadbolt sensor in accordance with embodiments of the present disclosure;

FIG. 7J is another block diagram of an exemplary spring-based deadbolt sensor in accordance with embodiments of the present disclosure;

FIG. 8 is a perspective view of components of an example door latching apparatus in accordance with the present disclosure;

FIG. 9 is a perspective view of components of an example door latching apparatus in accordance with the present disclosure;

FIG. 10 is a perspective view of components of an example door latching apparatus in accordance with the present disclosure;

FIG. 11 is a perspective view of components of an example door latching apparatus in accordance with the present disclosure;

FIG. 12 is a perspective view of components of an example door latching apparatus in accordance with the present disclosure; and

FIG. 13 is a perspective view of components of an example door latching apparatus in accordance with the present disclosure.

### DETAILED DESCRIPTION

Reference will now be made in detail to the exemplary embodiments and exemplary methods as illustrated in the accompanying drawings, in which like reference characters designate like or corresponding parts throughout the drawings. It should be noted, however, that the invention in its broader aspects is not necessarily limited to the specific details, representative materials and methods, and illustrative examples shown and described in connection with the exemplary embodiments and exemplary methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom” as well as derivatives thereof (e.g., “horizontally,” “vertically,” “downwardly,” “upwardly,” etc.) should be construed to refer to the orientation as then described or as shown in the drawing figure under discussion and to the orientation relative to door, door frame, etc. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixed (i.e., non-moveable) and connected together. Additionally, the word “a” and “an” as used in the claims means “at least one” and the word “two” as used in the claims means “at least two.”

Without limitation, the present disclosure relates to entryways, including any combination of doors, associated hardware (e.g., hinges, latches, strikes, etc.) and components (e.g., sensors, batteries, processors, etc.), surrounding areas where entryway components may be mounted or installed, door frames (noting that aspects of the frame can also include jambs (head jambs, side jambs), mullions, etc. (and noting, for the present disclosure, that aspects referred to as being in a frame should also be considered as being disposable in a sill or threshold, or indeed any portion in or around a traditional frame, including casing, brick mould (exterior casing trim), etc.), door slabs (e.g., foam filled doors, solid core fiberglass doors, steel exterior doors, molded panel MDF hollow or solid core interior doors, patio doors (which may have frames holding glass or other materials therein)), other frames, such as window frames, door lites, which may be in doors, e.g., as a window provided therein, or adjacent doors (e.g., providing windows left and/or right of an entry door), interior doors, hanging doors, folding doors, smart doors, etc.

As is described in exemplary embodiments herein, the present disclosure particularly relates to systems, methods and devices for hands-free entryways that includes at least one sensor configured to sense a user that is approaching an entryway, a latch disengaging mechanism, and a user feedback component that indicates to a user that the entryway can be used without requiring hands to unlatch a door. An entryway according to this disclosure can comprise a door pivotally attached thereto, a jamb and a frame.

In exemplary aspects, the at least one sensor detects any person approaching the entryway, e.g., as a motion sensor and/or camera configured with a pre-defined or user-definable sensing area. We note that such sensor may be configured to detect heat, motion, voice, video, mobile phone proximity (e.g., via Bluetooth, Wi-Fi, or NFC), ultra wide-band signals, RFID tags, biometric identifiers, or other user-specific characteristics. In exemplary embodiments, at least one sensor can be positioned within one or more of the door, the jamb and/or the frame of the entryway. In exemplary embodiments, the sensor is configured to optimally detect at a predetermined height and distance relative to the entryway. In one embodiment, such sensor is configured to optimally detect above pet height, e.g., at or above 1-3 feet from the ground. In further exemplary embodiments, the sensor is configured to optimally detect at a predetermined distance from the door, such as between 1 to 8 feet from the door, between 2-7 feet from the door, between 3-5 feet from the door, between 3-8 feet from the door, etc. In further exemplary embodiments, height and or distance can be configured by a user and/or installer, e.g., by physically adjusting the placement or position of the sensor and/or by adjusting the sensitivity/settings of the sensor.

In another exemplary embodiment, the sensing area is configured to be approximately 34 inches from the base of the door or from the sill, along the width of the door, and approximately 36 inches out from the face of the door. In exemplary embodiments, this permits a user to walk up to the door and have the door be activated without waiting for more than about a second. In further exemplary embodiments one or more of these measurements are adjusted by any increment up to about 3 further feet in any direction to tailor sensor coverage and door responsiveness. In exemplary embodiments, any movement outside a predefined or tailored sensor area will not trigger activation of the door system.

In additional exemplary embodiments, multiple sensors can cooperate to both detect and authenticate an approaching person (or user). For example, a motion sensor may initially detect movement in the sensing area, which then activates a camera for facial recognition or a Bluetooth receiver to detect a specific user's mobile device, thereby authenticating the user before unlatching the door. Once the sensors have successfully detected, authenticated, and triggered the unlatching mechanism, they can be configured to temporarily stop detecting or enter a dormant state until the door returns to its closed position, thereby preventing unnecessary power consumption and repeated activation while the user is passing through the entryway.

In further exemplary embodiments, the sensor will not cause the door to unlatch or a striker to energize to unlatch the entryway if the exterior ambient temperature is too high. In another embodiment, the sensor will not cause the door to repeatedly unlatch or a striker to energize to unlatch the entryway if a consistent heat source is detected over time (such as a hot engine block of a car). In another embodiment, certain consistent heat sources (such as a hot engine block) can be filtered out of the detection data, allowing for supplemental heat signatures (such as an approaching human) to only trigger entry through the doorway. For example, heat sensors may employ differential temperature detection algorithms that can distinguish between the relatively constant heat signature of a vehicle engine (which may register at 150-200° F. and maintain a consistent shape and temperature gradient) and the distinctive heat pattern of a human body (typically around 98° F. with characteristic head-and-shoulders thermal profile). As a result, the door system may be configured to recognize that a human heat signature approaching from the direction of a vehicle represents a user exiting their car and approaching the door, thereby appropriately triggering the unlatching mechanism despite the presence of the vehicle's heat signature in the background.

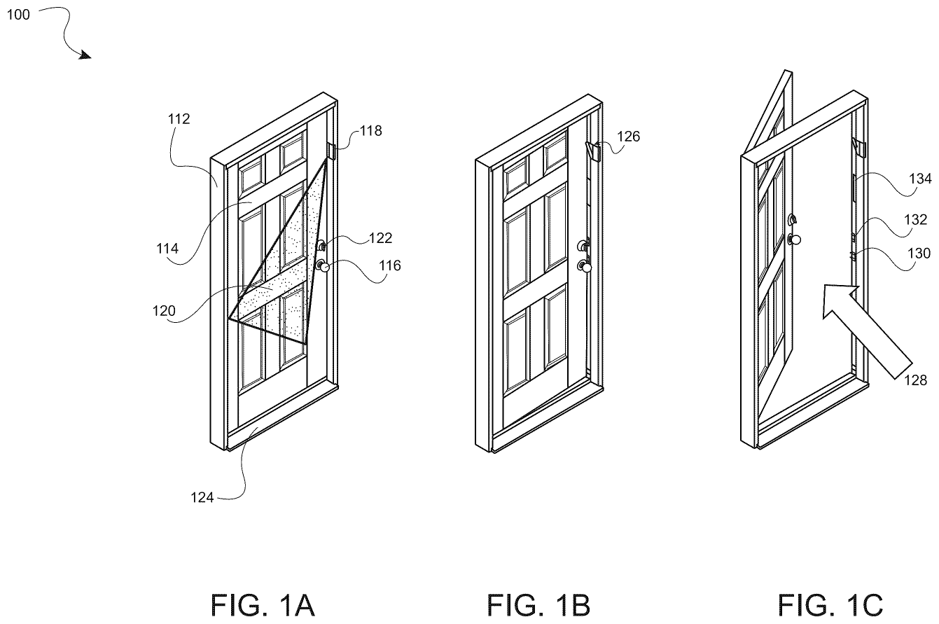

Referring to FIG. 1A, an exemplary door system 100 includes a frame 112 (note that when the present disclosure mentions a frame, exemplary embodiments also contemplate components within a threshold or sill 124), a door 114, a door latch 116 and at least one sensor 118. An exemplary sensor detection area is illustrated at 120, though it should be noted that the area need not be directly in front of the door, and indeed may be three dimensional (noting e.g., the below exemplary description, where one or more sensors and/or one or more cameras detects more than just presence, but also direction or inferred user intent for triggering entry). To that end, the door system 100 may employ machine learning (ML) and/or non-ML algorithm(s), such as convolutional neural networks (CNNs) for image recognition or recurrent neural networks (RNNs) for analyzing sequential data, to infer a user's intent to enter. For example, an ML algorithm may be utilized to analyze parameters such as a person's walking speed (distinguishing between someone passing by versus approaching with intent to enter), body orientation (facing toward versus away from the door), proximity patterns (gradually decreasing distance to the door rather than maintaining a constant distance), hand gestures (reaching toward the door or waving), or voice commands (detecting phrases like “open door”). In another example, the door system 100 may utilize a decision tree algorithm that weighs multiple factors simultaneously—for instance, if a person approaches within 3 feet of the door, slows their walking pace by at least 30%, and their body is oriented toward the door for more than 2 seconds, the door system 100 could determine with high confidence that entry is intended. These parameters and confidence thresholds may be customizable, e.g., via a user interface or administrator interface, locally or via cloud-based controls/UIs. In further exemplary embodiments, the system also includes a deadbolt 122.

Referring to FIG. 1B, the exemplary door system 100 of FIG. 1A is illustrated at 126 as being slightly ajar after unlatching by the system (e.g., by a processor making a decision according to data provided by the at least one sensor). While this exemplary embodiment illustrates partial opening by virtue of unlatching by the system, other exemplary embodiments contemplate the initial opening movement in a hands-free way, e.g., by a bump or nudge by the user, using the user's foot to pull or push the door open, etc. Exemplary partial opening by virtue of unlatching by the system can be achieved, in exemplary aspects, by e.g., providing weather stripping that biases the door to an open position, by providing a door opening assist mechanism, or by providing another pressure mechanism that biases the door to a slightly open position. As noted, in other exemplary embodiments, indication is provided that the entryway is unlatched, with the initial opening by a user's bump or nudge.

Referring to FIG. 1C, the exemplary door system 100 of FIG. 1A is illustrated at 128 as being in the open position, which would in this case be via hands-free opening (though the present disclosure contemplates automatic or other door openers and/or closers (e.g., spring or spool closers) in addition to the latch disengaging mechanism). The exemplary open position shown in FIG. 1C also illustrates an exemplary electric strike plate 130, a deadbolt interface 132, and a battery compartment 134 (which can be rechargeable, include commercially available disposable cells, etc.).

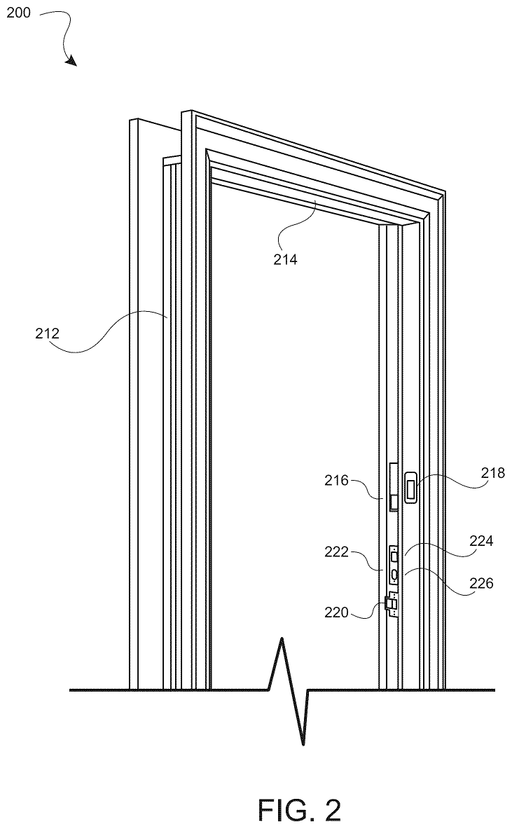

Referring now to FIG. 2, an exemplary deconstructed frame (specifically, jamb and trim construction (noting that we consider that components, in the present disclosure can also be provided within trim, or indeed brick mould, etc.)) is illustrated generally at 200, with jambs 212. In this illustrated exemplary embodiment, a sensor 214 is provided within the upper jamb, with a battery module at 216, a user interface module at 218 (which, e.g., provides user feedback indicating ability to enter via lighting, sound, etc.), an electric strike at 220 (which is activated to unlatch the door) and a combination deadbolt and ball detent plate at 222, which includes a detent or opening for the deadbolt at 224 and a ball detent at 226. We note that in exemplary embodiments, a cover ball latch, roller latch or magnetic latch may be used to retain the door in a closed position, as can one or more magnets used in the perimeter of the door. In some embodiments, the battery module 216 and the user interface module 218 can be combined into a single integrated module that houses both the power source and user feedback components. This combined module would contain the batteries needed to power the system while also incorporating the visual indicators (such as the LED lights that indicate door status) and audio components (such as buzzers or chimes) in a single housing. The integrated module could be designed to fit within the same jamb space, reducing installation complexity while maintaining all functionality. This combined configuration would allow for simplified wiring, more efficient power management by directly connecting the feedback components to their power source, and easier maintenance as both systems could be accessed and serviced simultaneously when the module is removed from the jamb.

In exemplary embodiments, the ball detent (or ball catch) assists in retaining the door in a closed position, with at least some minimal resistance that may be overcome by a user pushing against the door. In further exemplary embodiments, a sill component includes an articulating sill member (124 in FIG. 1A, which may be configured e.g., as an Endura Z-Articulating Cap sill member, such as at https://www.enduraproducts.com/products/sills-sill-systems/z-articulating-cap-sill/) that further (or in the alternative) assists retention of the door in a closed position by virtue of the pressure from the articulating cap on the underside of the door.

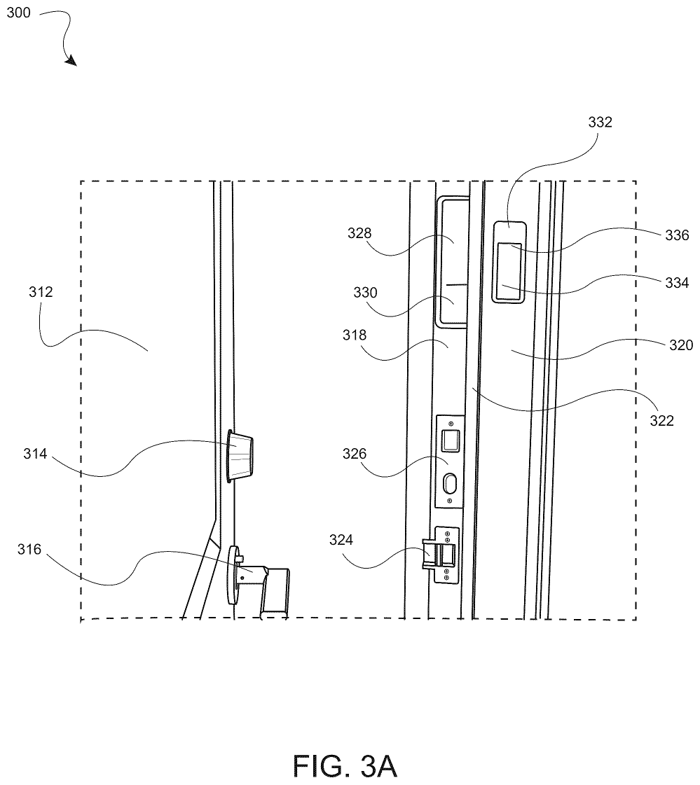

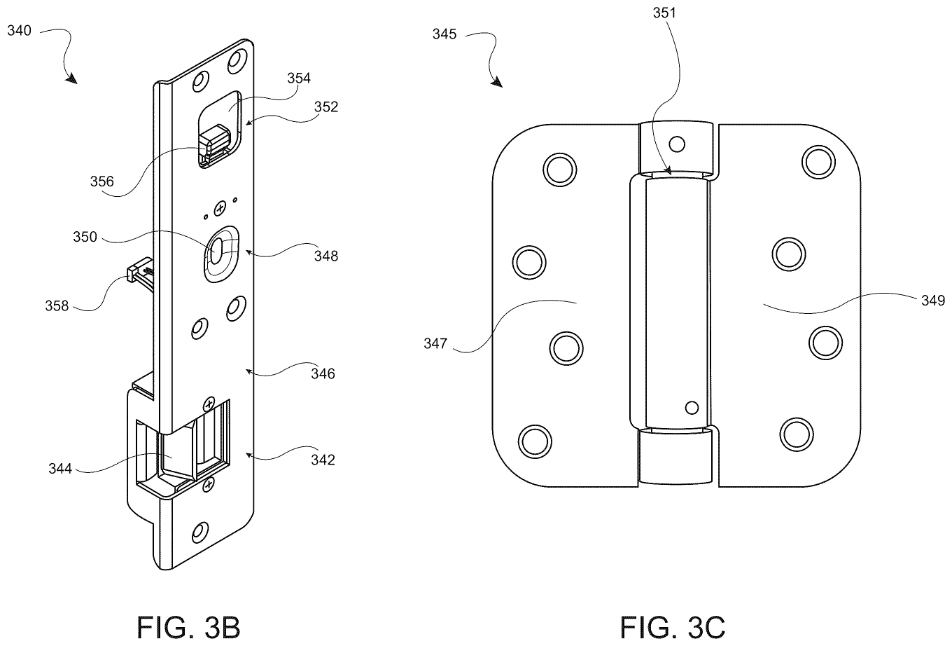

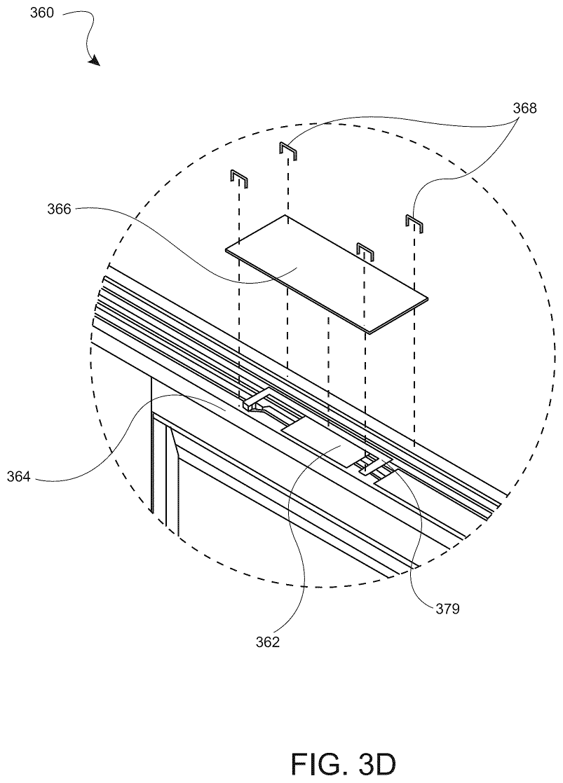

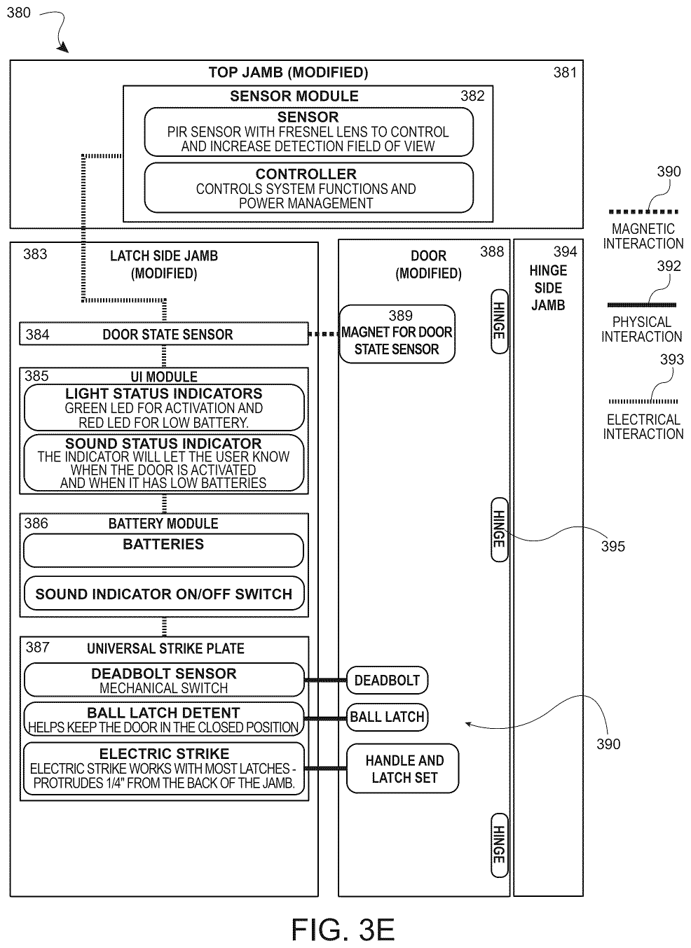

Referring now to FIG. 3A, an exemplary door system includes a door 312, with a deadbolt 314 and a latch 316 and inner and outer frame/jamb components, 318 and 320, respectively, separated by a divide/weather stripping/etc. at 322. An exemplary latch electric strike 324 is shown on the inner frame/jamb component 318, as is an exemplary combination deadbolt and ball detent plate 326 (also shown in FIG. 2). Further, in this illustrated exemplary embodiment, battery compartment 328 is also illustrated on the interior frame/jamb component 318. We note that in this illustrated exemplary embodiment, the battery compartment is flush with the jamb 318, but also includes a scooped-out portion 330 for a user's finger to allow the user to press up (in conjunction with tracks not shown here) to allow the cover to be removed for access to the battery compartment interior.

Referring now to FIG. 3B a perspective view of an exemplary integrated strike plate is shown generally at 340, which may be used in lieu of the separated strike 324 and deadbolt and ball detent plate 326 shown in FIG. 3A. Such integrated strike plate includes: a strike plate portion, shown generally at 342, including an electric strike 344 that receives and releases the door latch when electrically activated, allowing hands-free entry without manual retraction of the latch; a ball detent portion of the plate, shown generally at 348, with the detent for receipt of a ball (as part of a ball detent/roller latch, etc.) at 350 which functions to hold the door in a closed position with slight resistance that can be overcome by pushing against the door; and deadbolt plate area 352, with deadbolt aperture 354 and deadbolt sensor 356 that detects whether the deadbolt is deployed or retracted, providing critical information to the controller about whether hands-free entry should be enabled. Wiring for the deadbolt sensor 356 and for the strike 344 can be provided behind the integrated strike plate at 358. The integrated strike plate 340 provides a unified solution that combines multiple functions in a single assembly, though in other exemplary embodiments, the integrated strike plate may include different combinations of these elements-such as only the electric strike and deadbolt opening without the ball detent, or only the electric strike and ball detent without the deadbolt opening-depending on the specific requirements of the entryway installation.

Referring now to FIG. 3C, a front elevation view of an exemplary spring hinge plate (such as may be used for one or more of hinges 395 in FIG. 3B) is illustrated generally at 345. The hinge generally includes slab and frame side hinge plates 347, 349, and a spring hinge pin portion 351, which is configured to spring bias the hinge plate to the shown (door closed) position. While the exemplary illustrated spring hinge is provided by way of example, other door closing or biasing systems are contemplated herein, including active door closers, other springs, or bias based closing systems, etc., such as is known in the art. Examples of other closing devices include, without limitation, a pneumatic closer that utilizes compressed air to power the door closing device, a hydraulic closer that utilizes hydraulic fluid and pistons to control the closing speed of the door, a rack-and-pinion closer that utilizes a rack and pinion system to drive a door closing arm, and an electric motor-driven closer that utilizes an electric motor to control the door's closing movements.

Referring now to FIG. 3D, for any portions of the system that require either milling into a door frame or cutting through a door frame from the outside, fire retardant material can be provided either within the pocket resultant from milling out the frame, or outside the frame covering an area of installation to preserve fire ratings for the door system. Since many such installations will be for garages/fire rated door systems, such fire retardant and/or fire barrier material can be advantageous to maintain the proper rating. Such fire-retardant material can be any material such as is known in the industry.

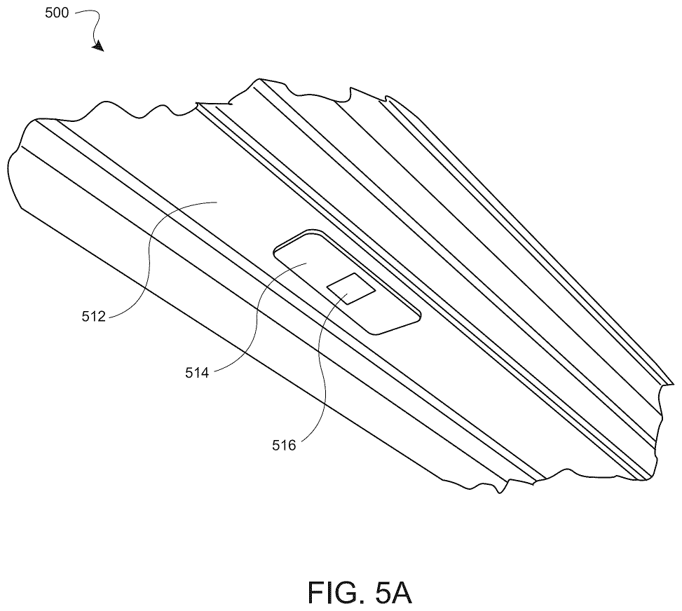

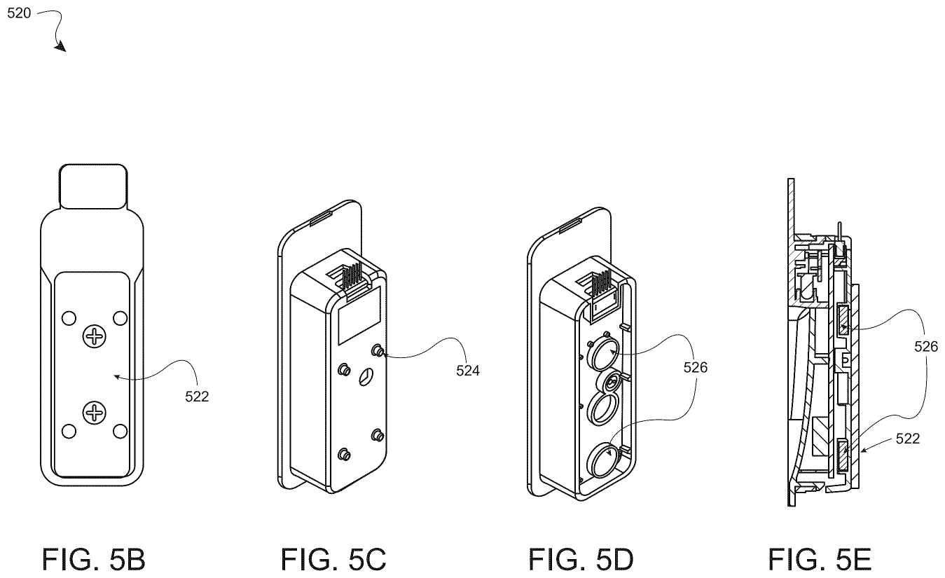

FIG. 3D illustrates generally at 360 an exemplary fire-retardant material 366 as a ceramic paper and intumescent tape 379 installed over a header jamb 364 (and over an installed system component 362 provided therein), secured by fasteners 368, such as staples. One or more magnets 526, shown in FIGS. 5D and 5E generally at 520) can also be provided therein above or behind the component 362, e.g., to facilitate downward removal when the door is open and easy reinstallation towards the magnet (allowing the module to pop in and out as desired when the door is open). Such a technique could also be used, e.g., for components 328 and 332 in FIG. 3A. With further reference generally to FIGS. 5B-5E, for any given module, in exemplary embodiments, a backing plate 522 can be provided that attracts one or more magnets 526 to facilitate rapid installation and removal of a module. In further exemplary embodiments, one or more alignment tabs 524 can be provided on the housing of a module to facilitate placement and proper alignment of that module in place.

FIG. 5B illustrates a front elevation view of a module backing plate 522, which is configured to be installed within a recessed portion of a jamb or frame. The backing plate 522 can include one or more mounting holes for securing the backing plate to the jamb or frame. The backing plate 522 can be made of a ferromagnetic material that can attract and hold magnets, thereby providing a secure attachment point for a removable module. FIG. 5C illustrates a perspective view of a module with alignment pins or tabs 524 extending from the rear surface of the module housing. These alignment pins 524 are configured to mate with corresponding recesses or holes in the jamb or frame to ensure proper positioning and alignment of the module during installation. The module shown in FIG. 5C can house various components of the hands-free entryway system, such as sensors, controllers, or user interface elements. FIG. 5D provides a perspective view of the interior of a module with magnets 526 installed within the housing. These magnets 526 are strategically positioned to align with the backing plate 522 when the module is installed. The magnets 526 create a strong magnetic attraction to the backing plate 522, allowing the module to be securely held in place without requiring additional fasteners or tools for installation. FIG. 5E shows a side plan view of an installed module, illustrating how the magnets 526 hold the module against the backing plate 522. This magnetic attachment system creates a secure connection while still allowing for easy removal when needed. The combination of the alignment tabs 524 and magnetic attachment system provides a dual-function mechanism that ensures both proper positioning and secure attachment. This configuration allows for quick installation by simply aligning the tabs 524 with their corresponding recesses and allowing the magnets 526 to pull the module into place against the backing plate 522. For removal, a user can simply pull the module away from the backing plate 522 with sufficient force to overcome the magnetic attraction, without requiring any tools. This design is particularly advantageous for maintenance, battery replacement, or system upgrades, as it allows for rapid access to the module components without damaging the surrounding frame or requiring specialized tools.

FIG. 3E illustrates an exemplary system architecture generally at 380, with a top (or header) jamb 381 including a sensor module 382 (with a sensor and controller, as is described herein). The latch side jamb 383 includes: a door state sensor 384; a user interface (UI) module 385, e.g., with light and/or sound indicators; a battery module 386, with batteries and, in exemplary embodiments a toggle switch for turning on and off an indicator, such as sound; and an integrated (or universal) strike plate 387, with a deadbolt sensor, ball latch detent and electric strike. The door (or slab) 388 includes: a magnet 389 for use with the door state sensor 384 (magnetic connection); and components 390 matching the integrated strike plate, i.e., deadbolt, ball latch and handle/latch (physical connection). Magnetic, physical, and electrical connections are shown at 391, 392 and 393, respectively. Hinge side jamb 394 in this illustrated exemplary embodiment only provides connection for spring hinges 395.

We note that while the exemplary system architecture of FIG. 3E shows discrete electrically wired components or modules, any such modules, e.g., UI Module, Battery Module and Sensor Module (or any other combination), could be in exemplary embodiments combined and placed wherever may be advantageous (e.g., all in the latch side jamb as one unit, leaving the top jamb alone).

In further exemplary embodiments, a door state sensor (not shown) may be included in any aspect, e.g., at or near the battery compartment 328, or anywhere else that allows the system to detect door state. In such exemplary embodiments, such a door state sensor may be used by the processor to understand when to power the latch/strike and when to stop powering the latch/strike (e.g., when the door is already opened), or when to notify the user about the door state (e.g., door open or closed).

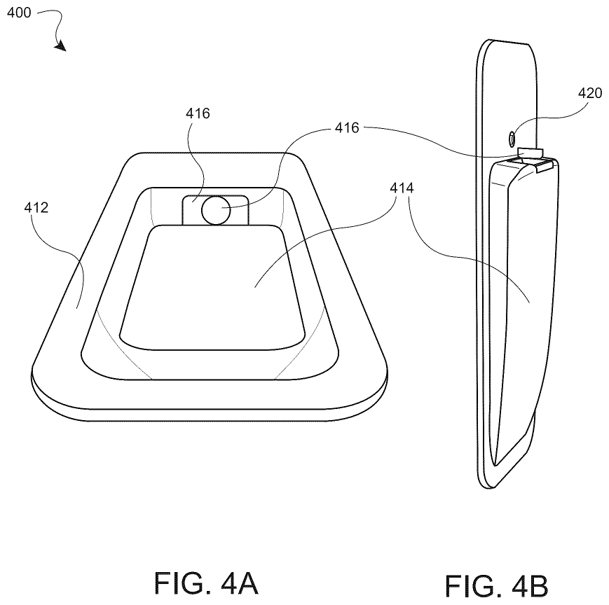

Additionally, in the illustrated exemplary embodiment, a user interface module 332, on the outside of the frame/jamb portion 320 (where the user would approach) also includes a scooped-out (recessed) portion 334 allowing the indicator LED or other light 336 to shine down and reflect over the surface of the scooped-out portion. This serves to broadcast the indicator to the user for better visibility of state. Other mechanisms for such broadcast contemplated herein include directing an LED beam towards a door component (e.g., a door slab, frame, jamb, sill, threshold, moulin, brick mould, door or other lite, etc.), spreading the light beam over that surface for such broadcast of indication of entryway status. As has been noted above, other status indicators are also contemplated herein, in the alternative or in addition, including sounds, indicators on user devices, etc. We also note that the system is configured, in exemplary embodiments, to enable and disable (e.g., as a toggle switch in the battery compartment) certain alerts or status indicators, such as for sound, as desired for an installer and/or a user. It should be noted that not only an unlatched indicator, e.g., a green light, can be displayed, but also other indicator lights (or sounds) may be displayed and/or broadcasted, e.g., a latched warning light (red, orange, customizable, etc.). Further, though not shown here, one or both of the user interface module and the battery module may also show, e.g., through a pinhole, a low battery indicator (e.g., as a red dot from an LED, of a desired size (different bleed through characteristics can provide a pinhole red light, a larger red light, or a red dot or blur with lighter coloring around it)) or provide a selectable or non-selectable audio indicator of low battery. FIGS. 4A and 4B further illustrate an exemplary user interface module generally at 400. The module includes a housing 412, with at least a portion of which is configured to be at least partially recessed within the entryway system (whether it be a door, frame, or other component). In exemplary embodiments illustrated by the preceding figures, the user interface module is configured to recess at least partially within a frame/jamb component., e.g., with portion 414 being recessed therein. A lens 416 is configured to diffuse the light into the interior of scooped portion 414 to broadcast the light from LED 418. Pinhole or deadfront and LED 420 (which may also optionally have a lens) provides the low battery light in this exemplary embodiment, which as illustrated (being a pinhole) would not tend to give light off unless the low battery LED is lit.

FIG. 5 illustrates a perspective view of an exemplary installed sensor module, generally at 500, in a frame/header jamb 512. The sensor module includes a body 514 and recessed portions (not shown) relative to the jamb 512. An exemplary lens 516 is provided for the sensor, which may be a motion sensor, camera, etc.

In further exemplary embodiments in line with FIG. 5 or otherwise, such sensor(s) and/or camera are configured along with a processor to determine whether a user is approaching the entryway. In further exemplary embodiments, such sensor(s) and/or camera are configured along with a processor to determine whether the user is approaching the entryway with the intent to enter, e.g., by inferring a user's intent to enter through the entryway by tracking the user over one or more periods of time while the user is in the sensing area of the sensor(s) and/or camera.

In other exemplary embodiments, a user device communicates with the at least one sensor to identify and authenticate the user and to authorize entry. Such a user device could be a user's mobile device, e.g., mobile phone, a user's automobile, a radio frequency device (e.g., RFID), a key fob (which can be RF-based or other), global positioning (GPS) device, magnetic device, Wi-Fi device, or other user device establishing an identity with the processor associated with the sensor.

In further exemplary embodiments, the at least one sensor authenticates users through one or more authentication methods including: biometric identification (e.g., facial recognition with 3D depth mapping, voice pattern analysis, fingerprint scanning, or iris recognition); mobile device authentication (Bluetooth handshake protocols, NFC proximity detection, app-based verification, etc.); and behavioral analysis (gait recognition or gesture-based commands), to name a few. As a result, a system according to this disclosure can be configured to operate in tiered security modes, with different authentication requirements based on time of day or security settings. For example, during daytime hours, motion detection alone might suffice, while evening access might require both biometric confirmation and mobile device verification. To that end, the processor can be configured integrate these authentication inputs through a weighted algorithm that calculates authentication confidence scores, for example. A user or administrator can configure these authentication parameters through a management interface, establishing specific entry conditions for different user types (e.g., family members, guests, service providers, etc.) and defining how the entryway hardware responds to each authenticated user (such as automatically adjusting door opening speed or activation time based on user preferences).

Additionally, any of the identification, authentication, and authorization for a particular user, if such is implemented, may be local, at the edge of the cloud or within the cloud, in various exemplary embodiments, or may be a part of user or administrator settings to configure such.

In further exemplary aspects, the latch disengaging mechanism is a latch retractor, e.g., an electric latch retraction device, as is known in the industry. In other exemplary aspects, the latch disengaging mechanism is at least one electric strike positioned in the door frame adjacent the latch. In further exemplary embodiments, a combination of one or more latch retraction devices and/or electric strikes may be used. In exemplary aspects, this may also be combined with a door actuator, as is known in the art.

In exemplary aspects in accordance with FIGS. 1-4 or otherwise, the user feedback component that provides indication to a user comprises one or more of: a light source, which may be color coded and may be discrete or which may be configured to exaggerate the indication by shining across one or more surfaces, e.g., the door or portions of the frame or components installed in the frame or door, for the user's benefit in order to know the status of the entryway. For example, a green light may be provided as shown in a module in the frame, or projected over a portion of the door or other flat surface (e.g., on a lite or portion of the frame/jamb, threshold or sill, etc.)

visible to the user, to indicate that the entryway is available for entry without use of hands to unlatch the door. Alternately, another color or shade may be used to indicate that the door is not unlatched. Other indicator lights, e.g., for battery status, may also be used, though in exemplary aspects, they may be more discrete light sources configured to provide status but not be more widely broadcast (e.g., a pinhole as in FIG. 4B in a user module that also broadcasts an open status, with the pinhole configured not to bleed a red light or other color through the housing, but instead to only show a pin of red (or other) light outside the frame or other user module position).

Additionally, in other exemplary aspects, a battery module can be separate from the user interface module (but can provide power thereto, as well as to other components, such as a strike plate, etc.) and can itself (e.g., in the alternative) provide a status indicator (e.g., a red light that provides a discrete indicator of status rather than a broadcast, spread out light emission).

Other exemplary user feedback mechanisms (indicating that the door is unlatched or to otherwise provide the status of the entryway, at least during such indication), include but are not limited to sound, moving of the door, communication with user devices, other feedback, etc.

In further exemplary aspects, a programmed flow can be used, which may be pre-set, user-set or administrator-set (including user or administrator configurable as well), which can also include timings (which term also includes periodic checks over time), e.g., for the time for powering of an electric strike to the time for deactivating the power to the strike, time to actuate a door (if actuator elements are present for opening and/or closing, or even bumping a door, are present), times to notify a user of door status, whether by visual indicators, sound indicators, user device indicators, etc., times to check battery or other status metrics, times to check or recheck the status of deadbolts (even as it relates to partial deployment of such deadbolts), etc.

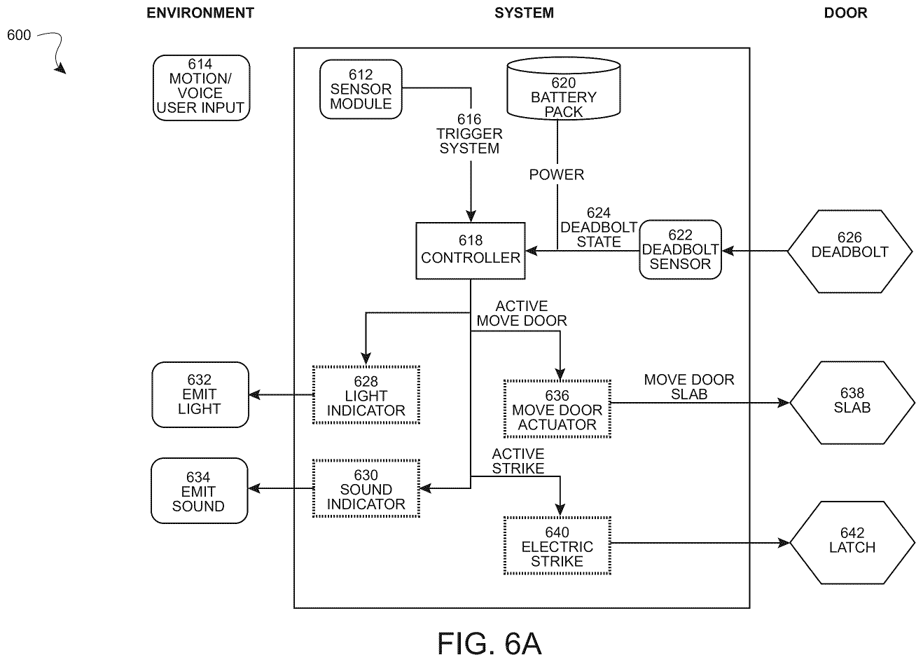

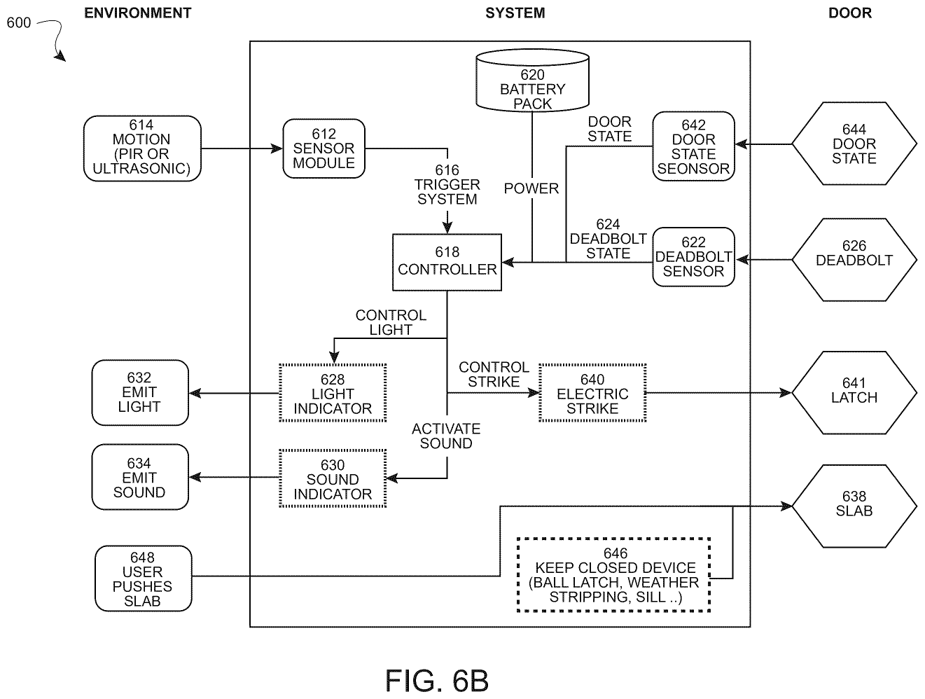

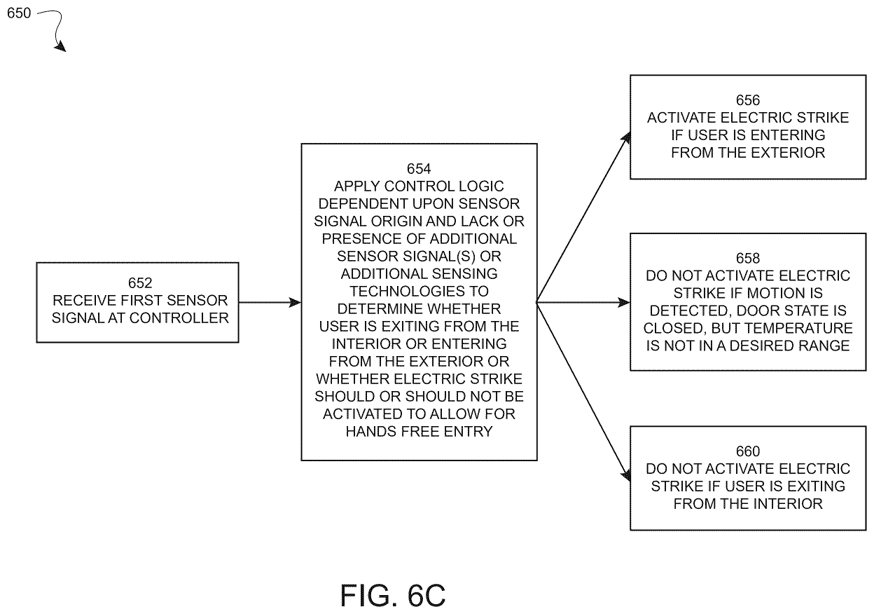

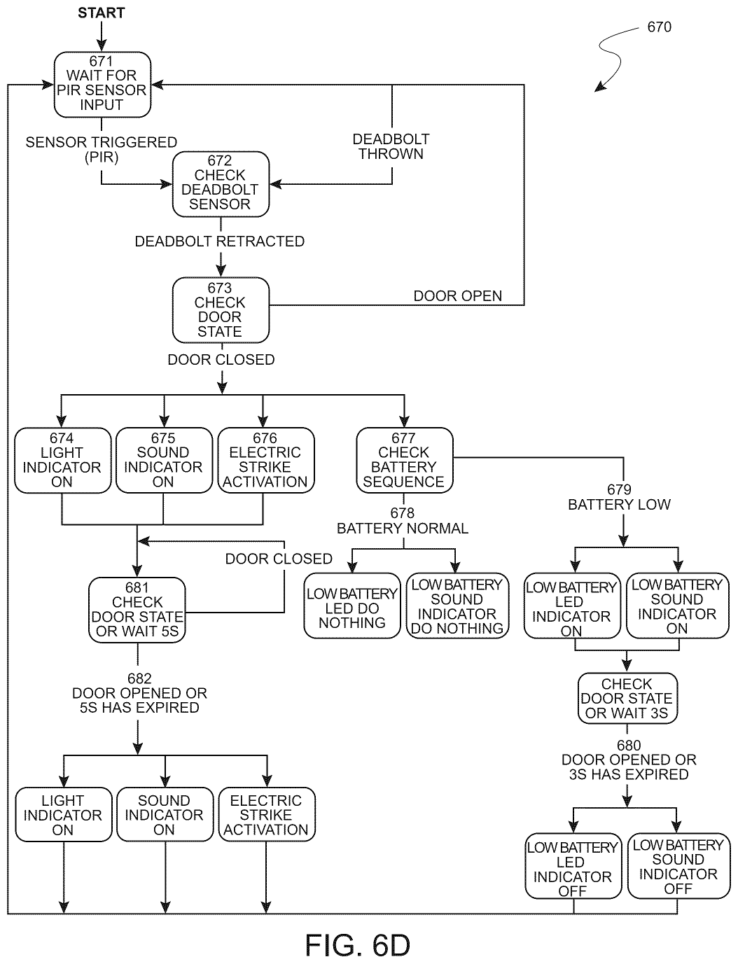

FIG. 6A illustrates a flowchart showing an exemplary system and method of operation generally at 600. In the illustrated exemplary embodiment, at 612 a sensor module receives motion, voice, or other user input at 614. This triggers, at 616, a controller 618, which is powered by a power source, in this case battery pack 620. In this exemplary embodiment, as will be discussed in more detail below, a deadbolt sensor 622 provides a deadbolt state 624 from a deadbolt 626. If the deadbolt is deployed, or in embodiments, even partially deployed, the controller does not actuate the lock and either does not provide indication of an accessible entryway or provides an indication of an inaccessible entryway. Exemplary light and sound indicators are shown at 628 and 630, respectively, with environmental emission at 632 and 634, respectively.

With further reference to FIG. 6A, should the controller actuate the door, along with indicator(s) of such, one or both of a door actuator 636, actuating a door slab 638 and an (or one or more) electric strike 640, freeing a latch 641 are powered to allow entry. In exemplary embodiments, if the user does not pass through the door within a predetermined amount of time, e.g., between 3 and 10 seconds, between 4 and 8 seconds, within 5 seconds, etc., then feedback indicators turn off letting the user know that the door cannot be pushed open without the latch being retracted or the system being activated again. In such a case, the electric strike stops receiving power; and the door is returned into its home position (closed and latched, with the electric strike not powered). In other exemplary embodiments, intermediate sequences and user feedback can be used to provide the user warning before the electric strike stops receiving power (to let the user know that they are running out of time).

In further exemplary embodiments, once the user passes through the door, the door state sensor signals to stop powering the electric strike and the feedback indicators that let the user know the door can be pushed and opened without retracting the latch. Any triggering by the sensing module, and following unlatch procedures are seized until the door is back in its home position. This ensures that the door electronics do not keep activating while it is being used.

When the user passes through the door, spring hinges or another closing device closes and relatches the door, after which the door is now back in its home position. At this point, the door is closed, latched, with the electric strike unpowered, feedback indicators communicating door needs to be activated or the latch needs to be retracted to open the door, and with the sensor is ready to sense a person again.

In further exemplary embodiments, if the user locks the door using the deadbolt, the deadbolt sensor gets activated and communicates via its feedback indicators that the system is either off or the door is locked. The indicators will not change, and the strike will not be powered while the deadbolt sensor senses the deadbolt. This security feature ensures that when the deadbolt is engaged with the door slab, the entire hands-free entry system becomes inoperable, preventing any attempt to bypass the deadbolt through the electronic components. Specifically, once the deadbolt sensor detects engagement, the controller immediately disables all electronic strike activation capabilities and enters a dormant state where it ignores any motion detection or other sensor inputs that would normally trigger the hands-free entry sequence. This prevents unauthorized access attempts even if someone attempts to manipulate the sensor systems, as the mechanical deadbolt engagement serves as a physical override that cannot be circumvented by the electronic components. As has been noted, this protects the user from trying to push a locked door and provides an additional layer of security when the home or building is intended to be secured against entry.

Further exemplary aspects of the presently described system features light and sound indicators that notify the user when the systems batteries are low. When the user activates the door via the sensing module a flashing red LED can also be seen for 3 seconds (though this time may vary) in addition to the continuously on green LED this indicates low batteries. And in addition to the normal buzzer sound that is mentioned above as the secondary feedback mechanism; in exemplary embodiments an additional unique sound is heard that indicates low batteries. If used in combination, these two low battery feedback will get the users attention and help them notice that the batteries need to be changed.

FIG. 6B provides another exemplary flow chart, similar to that of FIG. 6A, but lacking the door actuator 636. Additionally, a door state sensor 643 detects a door state 644, as has been described herein. Item 646 also illustrates a keep close device, such as a ball latch, weather stripping, aspects of the door sill, etc., used to keep the door closed until the user pushes the slab at 648. In such an exemplary case, if the system is triggered, the door does not move unless the user interacts with it (e.g., via a hands-free push/pull, which also may be considered as part of a safety feature).

FIG. 6C illustrates generally at 650 a method or system processing flowchart for another exemplary mode of operation. In exemplary aspects, receipt of a first sensor signal, such as a motion or door state sensor is illustrated at 652. At 654, control logic is used, dependent upon sensor signal origin and lack of presence of additional sensor signal(s) to determine whether a user is exiting from the interior ore entering from the exterior, or whether the electric strike should or should not be activated to allow for hands-free entry.

For example, the timing of receipt of signals (or lack of receipt of signals at a given time) from the door state and/or deadbolt sensors (642 and 622, respectively in FIG. 6B) and the motion sensor 614 is used to infer how a user is approaching and utilizing the door. For example, if the door state sensor 642 and/or deadbolt sensor 622 is activated (the door state sensor showing an opened door or the deadbolt sensor showing an unlocking) prior to receipt of or without receipt of a signal from the motion sensor 614), the system can infer that the user is moving from the house, internally to the exterior. By contrast, if the first signal is from the motion sensor, the system can infer that a user is approaching the door from the external space (outside the door).

As such, the controller can be configured to not power on the electric strike when the user is moving from the house, internally to the exterior, and instead to only power on the electric strike when the user is approaching the door from the exterior for hands free entry.

Determining that a user is exiting the interior and not activating the electric strike has a benefit of leaving the latch engaged when the user is moving through the door from the inside so that the door will latch/not rebound when it closes (e.g., for aggressive closing). Further, ensuring positive closure/naturally latching upon closing when a user moves from the interior to the exterior or garage prevents wind from blowing the door open and, in the case of a garage, ensures fire safety compliance, since the door would only unlatch when sensing someone moving in the garage.

This also advantageously reduces power requirements/power consumption for door uses where the electric strike is not needed (which can provide great advantage when the electric strike is battery driven).

A further exemplary advantage is that such a control system allows the system to measure occupancy for other or later use cases, e.g., automated lights when exiting/entering a garage or other external space relative to the interior.

In exemplary embodiments, the system is configured to provide a predetermined and/or configurable delay after determining that the user is moving from the interior to the exterior (e.g., delaying possible activation of the strike for 5 seconds, 10 seconds, 30 seconds or any desired amount of time such that the door will relatch upon closing, not provide a delay to closing or latching the door, not cause the door to bound open, etc.) such that the electric strike would not activate for hands free entry when a user exits from the interior but would properly activate to provide for hands free entry when the user returns to re-enter from the exterior (even after only a short period of time).

In further exemplary embodiments, the controller is configured to monitor a predetermined or configurable time value of a door state sensor to determine whether to activate the electric strike and provide for hands free entry. For example, upon receipt of a signal from the motion sensor, recognizing that the door has been closed for a predetermined or configurable amount of time, inferring movement from the exterior to the interior, and activating the electric strike only if that amount of time (e.g., 5 seconds, or another preset, system configurable or user configurable value) is met or exceeded.

In the case of an interior to exterior (e.g., garage) entryway the below example provides that the inferred direction of the user controls whether the electric strike is activated to unlatch the door:

```
//trigger event
If Motion Status is Detected
  {
    //user is coming from garage
        if Door has been closed for 5s
      unlatch door
    //user is coming from interior
    else
      do nothing
  }
```

In additional exemplary embodiments, the present disclosure recognizes that it may not be advantageous to unlatch the door when the temperature around the door is not in a desired range. The use of temperature sensors and/or thermal fuses may be incorporated anywhere on or around the door system to detect temperatures, which may be compared against undesirable predetermined or at least partially configurable ranges. Should the temperature be in an undesirable range or outside of a desirable range, the controller may be configured to not activate the electric strike and provide hands-free entry. The temperature range can be confirmed or supplemented by various other sensors (including the existing motion sensor) to verify that the electric strike should not be activated. Further, a temperature sensor can also be used to calibrate a motion sensor to ensure that any motion detected is the user rather than an artifact.

In other exemplary embodiments, a low-power/less accurate sensor (e.g., PIR sensor) can be used to wake up the system when a user approaches the door, with a higher-power/more accurate sensor (such as an ultrasonic/time of flight (ToF) sensor to measure the distance of a user to the door and the direction the user is going in) used to provide data relative to user intent (e.g., if a user intends to go through a door). Additionally, any given sensor can be configured to use different sensing technologies for additional accuracy.

Referring again to FIG. 6C, exemplary decisions are illustrated at 656, 658 and 660 (though other decisions or control logic processes are contemplated herein). At 656, the electric strike is activated if the user is entering from the exterior the door is closed and deadbolt is unlocked. At 658, the electric strike is not activated even if door motion is detected and the door state is closed if the environmental temperature is not in a desired range (note that 658, if the system is so configured with a temperature sensor) would have a higher priority than 656). At 660, the electric strike is not activated if the user is exiting from the interior. We again note that these are general exemplary control logic decisions, with others possible control logic decisions including use of, e.g., any timeout or delay aspects, use of plural sensors or sensor technologies, etc. also contemplated herein.

FIG. 6D shows a further exemplary system logic diagram at 670, with a sensor triggered at 671. At 672, the deadbolt sensor signal is checked; and if the deadbolt sensor detects a thrown (engaged) deadbolt, then the logic returns to the start. If the deadbolt is retracted, then the door state is checked at 673. If the door is open, the logic returns to start. If the door is closed, (at least one of) multiple actions are taken. At 674, 675 and 676, a light indicator is turned on, a sound indicator is turned on, and the electric strike is activated, respectively. Additionally, at 677, the battery sequence is checked. With regard to the battery sequence in a battery normal condition at 678, neither of a low battery sound or light indicator are engaged. In a battery low condition at 679, such sound and LED indicators are activated, followed by either a check of the door state (via door state sensor) or waiting a predetermined time (such as 3 seconds). At 680, if the door is opened or if the predetermined time has expired, the indicators turn off and the system resets to start. With regard to post-activation of the strike and any audio/visual indicators, the door state is checked or there is a wait for a predetermined amount of time (such as 5 seconds) at 681. To the extent that the door remains closed up to that predetermined time, nothing happens. If the door is opened or if the predetermined time has expired, then the audio/visual indicators turn off and the electric strike deactivates, such is generally shown at 682; and the system goes back to the start state.

As has been noted briefly above, exemplary embodiments include a deadbolt sensor that detects one or both of a deadbolt locked condition or partial deployment of a deadbolt triggers a processor routine (e.g., at a controller) that indicates that the entryway is not accessible. In such exemplary circumstances, the system either does not emit a light, sound (e.g., a buzzer, chime, custom sound, etc.) or other indication in accordance with such, or that provides indication that the door is not ready for entry to the user (using any available mechanism for the user). If there is a door actuator and/or door strike, such a deadbolt sensor could also be utilized to override open control signals for those aspects, e.g., to prevent a user from bumping the door without the door being able to be opened. In further exemplary embodiments, the system can be configured to go into a sleep state when the deadbolt sensor detects that the deadbolt is deployed.

In some embodiments, the system detects partial deployment of the deadbolt by measuring the proximity of the deadbolt to the edge of the door frame using capacitive, inductive, or ultrasonic sensors, for example. To illustrate, an ultrasonic or time of flight sensor positioned in the door frame can measure the precise distance between the sensor and the end of the deadbolt, allowing the system to determine if the deadbolt is fully retracted, partially extended, or fully extended. Similarly, capacitive sensors can detect changes in capacitance as the deadbolt approaches the door frame edge, with different capacitance readings corresponding to different degrees of deployment. This granular detection capability ensures the system can identify even slight extensions of the deadbolt that might not fully engage the strike plate but would still prevent proper door operation.

Exemplary methods for detecting a state of a deadbolt include inductive proximity sensors that can sense any metal, and in particular ferrous based alloys. Such techniques use a metallic target opposite an active face connected to a coil, oscillator trigger circuit and switching device, also connected to a load to create a sensing field between the active face and the metallic target. Other exemplary methods include capacitive proximity sensors, providing a target and a plate, also with an oscillator, trigger circuit and an O/p switching device. Further exemplary methods include photo-eye sensors, e.g., using a light emitting element providing a signal light for a target that interrupts the signal light prior to receipt at a light receiving element or a combination transmitter and receiver that relies upon a reflected light from a target. Another method includes ultrasonic ToF (time of flight) sensors, also with a transmitter and receiver reliant upon a reflected signal from a target object to determine the object's presence. In exemplary embodiment described herein, any of the preceding mechanisms can be mounted, for a deadbolt, 360 degrees around a deadbolt bore-hole close (e.g., as close as possible) to the face plate for effective sensing.

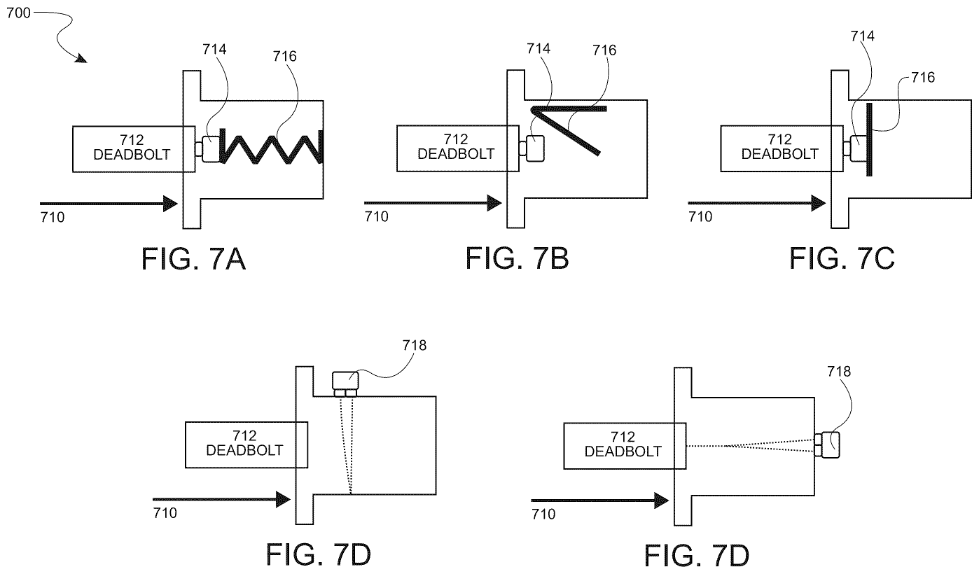

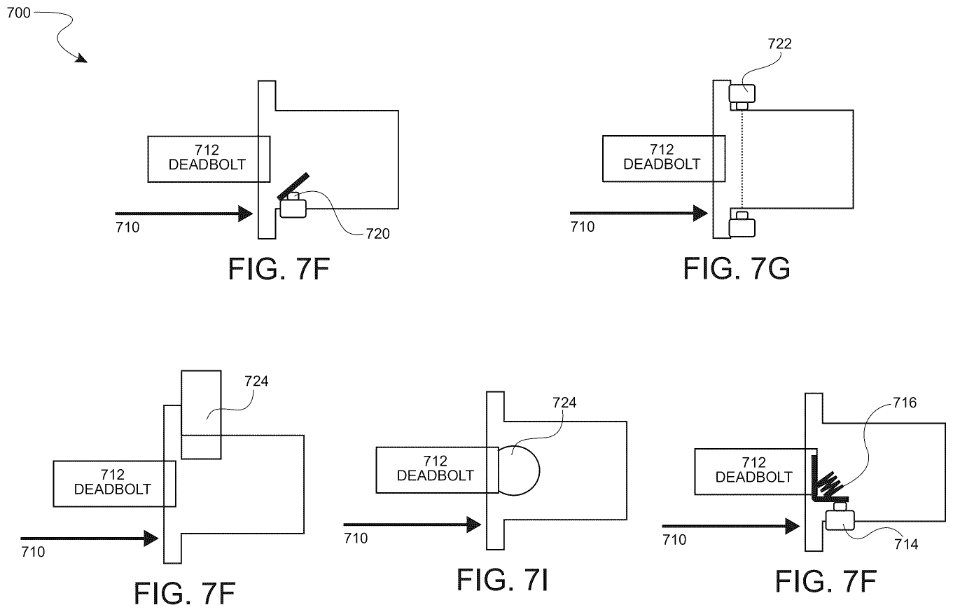

Further methods for deadbolt sensing may include lever actuated or spring-loaded mechanical switches, with arrow 710 showing at least partial deadbolt deployment, e.g., as illustrated in FIGS. 7A-7C for spring-based mechanisms (note deadbolt 712, with extension/switch 714, against springs 716 of different configurations), or as illustrated via ultrasonic or other ToF sensors in FIGS. 7D-7E (note deadbolt 712 relative to sensors 718), or vie a stop switch actuated by a deadbolt as in FIG. 7F (note deadbolt 712 relative to stop switch 720 (which may be similar to or the same as 714), or via a photo-eye line of sight sensor as in FIG. 7G (note deadbolt 712 relative to line of sight sensor 722), or vie inductive/capacitive non-contact sensors mounted on the y-axis (FIG. 7H) or z-axis (FIG. 7I) (noting the deadbolt 712 relative to the sensors 724). FIG. 7J is another block diagram of an exemplary spring-based deadbolt sensor with spring 716 and extension/switch 714.

Exemplary aspects of the present disclosure advantageously provide systems, methods, and devices for hands-free entryways for a variety of different use cases and users that would benefit from such. Further, the presently described systems, methods and devices are efficient, cost effective (such that they are suitable for residential use) and easily incorporated, e.g., in the frame of existing doors, or indeed in portions of the frame or surrounding portions (e.g., brick moulding, trim, head jambs, side jambs, etc.) such that they can be retrofitted to existing entryways. Additionally, where elements are fitted around a door, rather than in the door itself, such does not affect fire ratings or other tested aspects of the doors themselves. Exemplary aspects also provide for preventing unlatching of the door if a sensor detects that a deadbolt is at least partially deployed, providing for a more secure, safe, and efficient product. Further exemplary aspects provide for re-closing of doors, facilitated by e.g., an integrated ball detent, pre-configured weather stripping, or in embodiments positive opening and/or closing devices.

Other latching types and configurations are also contemplated herein, e.g., those described in co-owned U.S. Pat. No. 11,174,664, filed Mar. 20, 2019, the entire contents of which are incorporated herein by reference. While the present disclosure also contemplates use of automatic door opening/closing/positioning systems and components, use of remote signals, hubs, user devices, etc., to control opening, closing or repositioning of doors, or to control unlatching of doors, the below reiterates aspects of U.S. Pat. No. 11,174,664 as it relates to control of exemplary motorized latching mechanisms as from U.S. Pat. No. 11,174,774 and otherwise.

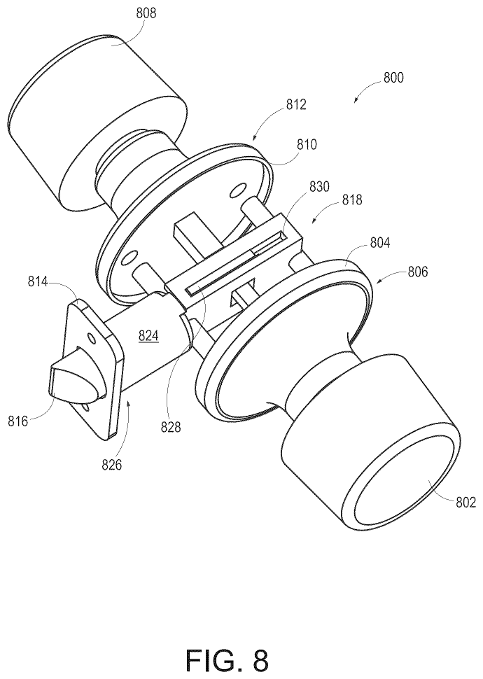

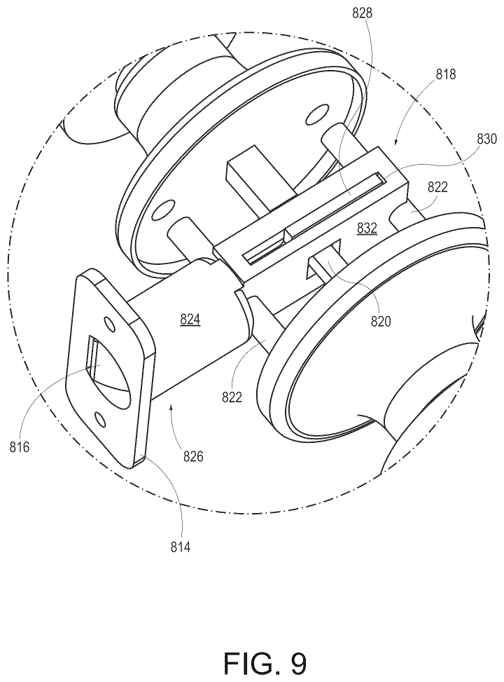

FIGS. 8-13 are various views of components of a door positioning system in accordance with the present disclosure. FIGS. 8 and 9 include a doorknob assembly 800, with a latch in an extended position (FIG. 8) and in a retracted position (FIG. 9). The doorknob assembly 800 includes a first handle 802, first handle rosette 804 including a spring assembly 806, a second handle 808, and a second handle rosette 810 including a spring assembly 812. The doorknob assembly 800 may also include a spindle 820 with two fasteners 822 extending from the first handle 802, each fastener 822 positioned on either side of the spindle 820. The fasteners 822 and spindle 820 may be coupled to a latch assembly 818, and the spindle 820 may also be coupled to the second handle 808.

The doorknob assembly 800 also includes the latch assembly 818, which includes a plate 814 positioned at an end of the latch assembly 818, the plate 814 connected to a latch housing 824 connected to a cage 832. The latch housing 824 includes a hollow central portion. A latch 816 is positioned within the latch housing 824 and the hollow central portion, with a spring assembly 826 and coupled to a transmission plate 828 positioned within the cage 832. A top portion of the transmission plate 828 extends through a slot 830 formed in the top of the cage 832.

In operation, a user may rotate the first handle 802 or the second handle 808, causing the spindle 820 to rotate. The rotation of the spindle 820 causes the transmission plate 828 to move within the cage 832, thereby horizontally moving the latch 816 to retract within the latch housing 824. With enough rotation of the spindle 820, the end of the latch 816 is fully retracted within the latch assembly 818 and the end of the latch 816 does not extend past the plate 814 (as shown in FIG. 9). In this position, the latch no longer engages with a catch plate in the corresponding door frame, and no longer fixes the position of the door with respect to the frame. Upon release of the first handle 802 or second handle 808, the spring assembly 806 and 812 will rotate the spindle 820 back into the resting position, as shown in FIG. 8, with the end of the latch 816 extending past the plate 814. A user may also push on the end of the latch, compressing spring assembly 826, and the latch 816 will slide into the latch assembly 818 without turning either the first handle 802 or the second handle 808. Once the user releases the latch 816, the stored energy in the compressed spring assembly 826 is released, and the latch returns to its resting position.

In some examples, the door unlatching system may include the doorknob assembly 800.

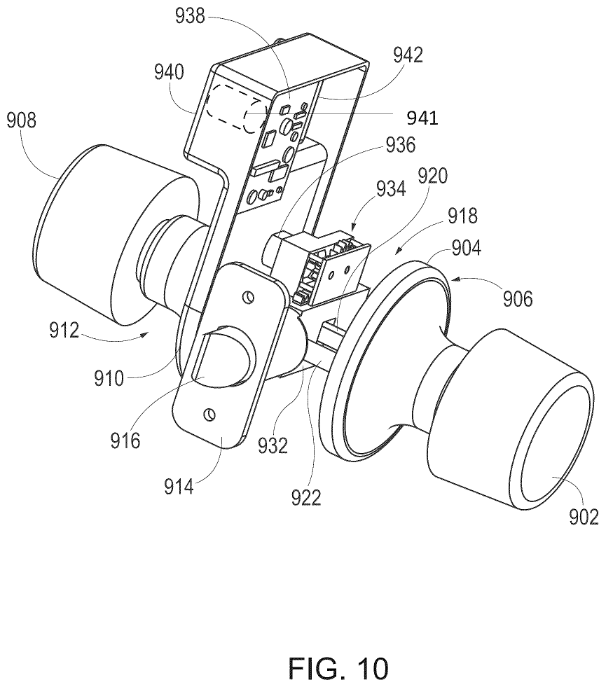

FIGS. 10-13 are various views of components of an example door positioning system in accordance with the present disclosure.

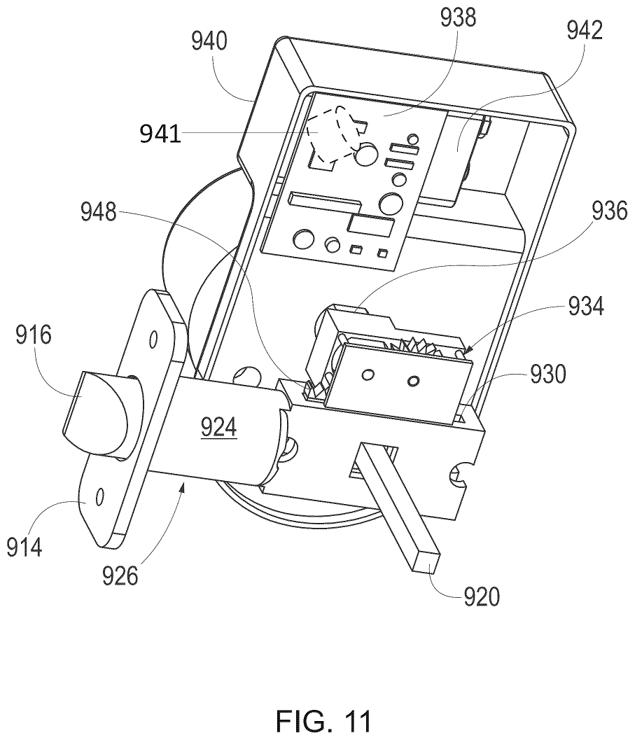

Similar to FIG. 15, FIG. 10 includes a doorknob assembly 900 with a first handle 902, a first handle rosette 904 including a spring assembly 906, a second handle 908, and a second handle rosette 910 including a spring assembly 912. FIG. 11 is similar to FIG. 10, but without the first handle 902, first handle rosette 904 and spring assembly 906. The doorknob assembly 900 also includes a spindle 920 with two fasteners 922, each fastener 922 positioned on either side of the spindle 920. The fasteners 922 and spindle 920 may be coupled to a latch assembly 918, and the spindle 920 is coupled to both handles 902 and 908. The doorknob assembly 900 also includes the latch assembly 918, which includes plate 914 positioned at an end of the latch assembly 918, the plate 914 connected to a latch housing 924 connected to a cage 932. A latch 916 is positioned within the latch housing 924, with a spring assembly 926 and coupled to a transmission plate 928 positioned within the cage 932. A top portion of the transmission plate 928 extends through a slot 930 formed in the top of the 932.

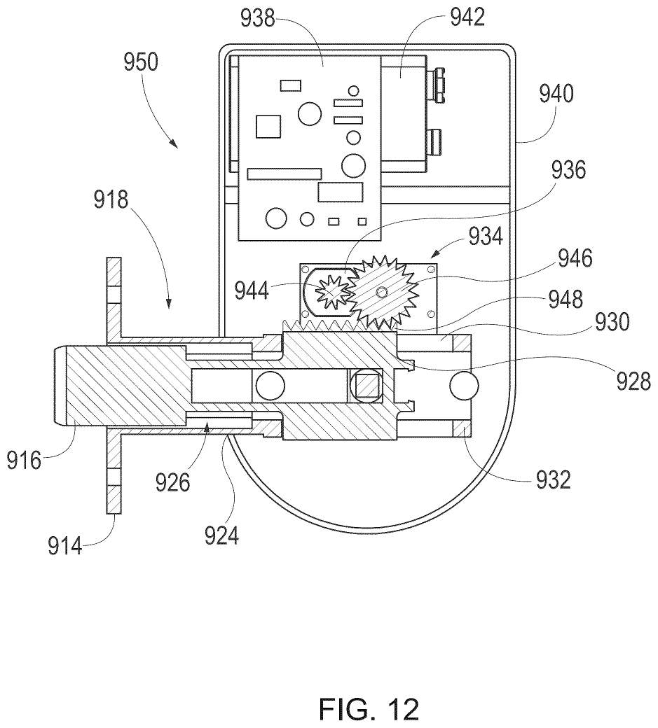

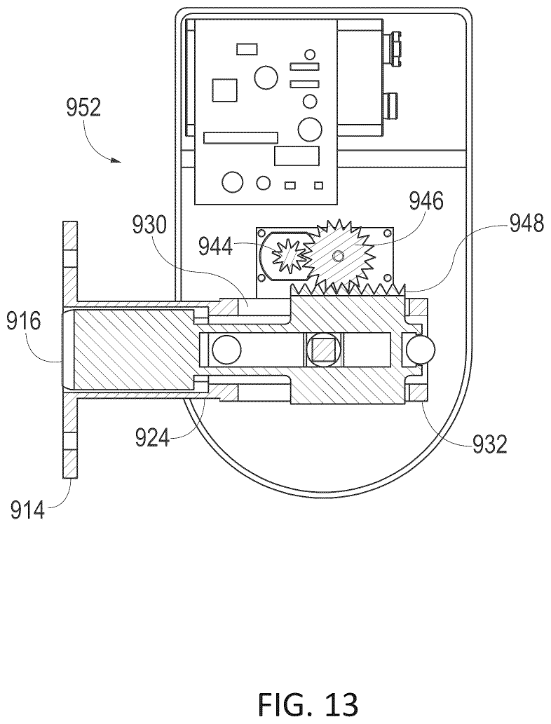

In addition, doorknob assembly 900 may also include motor 936 and gearbox 934, the output of the gearbox 934 coupled to a gear rack 948 positioned on the top edge of the transmission plate 928 (see FIGS. 12 and 13). While a gearbox is shown in FIGS. 10-13, other types of power transmission assemblies may be used, such as clutches, belt drives, and the like. The engagement of the motor 936 with the transmission plate 928 may also be accomplished using a gearbox 934 and gear rack 948, with the gear rack 948 not directly coupled to the transmission plate 928 but forming a cage around it. The doorknob assembly 900 may also include a PCBA 938 and battery 942 electrically coupled to the motor 936 to help power and control the motor 936.

FIG. 12 is a view of the latch assembly 918 in a latch engaged position 950. FIG. 13 is a view of the latch assembly 918 in a disengaged latch position 952, with the latch fully retracted within the latch housing 924.

In some examples, the power transmission assembly is coupled to the doorknob motor and translates a rotational movement of the doorknob motor to a linear movement of a latch mechanism responsive to receipt of the signal. The latch disengaging mechanism may include an electric strike with a solenoid that, when energized, pulls a catch or keeper out of the way, allowing the door latch to swing freely past the strike plate without manual retraction.

Alternatively, the latch disengaging mechanism may include a latch retractor with a motor-driven mechanism that directly retracts the latch bolt. In some embodiments, a motor with a rotary or swivel mechanism can be used to initiate the unlatching process by rotating a cam that disengages the latch from the strike plate. The electric strike may also incorporate a fail-secure or fail-safe design, determining whether the door remains locked or unlocked during power loss. In some examples, an exemplary door positioning system will be engaged after the latch mechanism is confirmed to be disengaged from door frame.

The power transmission assembly include the gearbox 934 and the doorknob motor 936. The gearbox 934 may include a driver gear 944 and a driven gear 946. In some examples, the driver gear 944 is coupled to the output shaft of the doorknob motor. The driver gear 944 engages with the output gear, or driven gear 946 of gearbox 934, which then engages the gear rack 948 attached to the transmission plate 928 extending out of the slot 930. When triggered by a signal sent by a remote computing device, the motor 936 turns on and the engagement of the driven gear 946 with the gear rack 948 retracts the latch 916 within the latch housing 924, disengaging the latch 916 from holding the door in place.

After a designated time or other signal sent from the remote computing device, the motor 936 returns the transmission plate 928 to its original position. In the example of doorknob assembly 900, the second handle rosette 910, is expanded to include a housing 940 to provide space for the PCBA 938 with wireless control and operation and battery 942. The housing 940 may also include buttons that enable a user to access or control the motor 936 and related mechanisms.

While certain embodiments describe both powered unlatching, e.g., via use of a motor 936 to use power to disengage the latch 916 and also to re-engage the latch 916, in further exemplary embodiments, if the friction of the doorknob assembly is low and the spring force of the return spring is able to overcome the friction and positively return the latch to a latched state, then re-latching can be performed by removing power to the motor 936 and allowing the return spring's force to re-latch the door without power.

Re-latching may be performed according to any method described herein (in this later case by simply discontinuing power to the motor when the timer expires), including for example use of wireless communication to provide the signal to re-latch or disengage power for re-latching, via a push button (or touch pad, actuator, etc.) on the door assembly or doorknob, with the pushbutton only powering the motor over a short time to unlatch the door and hold it unlatched, or any other communication or operation technique contemplated herein. In the case of use of a pushbutton, the pushbutton can be provided by itself, without any computing devices, or in addition to computing devices and unlatching signals communicated to the powered unlatching system, as another option for a user to manually unlatch a door.

In further exemplary embodiments, the door or doorknob itself can also include a motion/proximity sensor, etc., that can be used to trigger the unlatching of the doorknob assembly. This or other sensors can be built into the door or doorknob in any convenient location that provides a view towards an approaching user, e.g., the handle, a base plate, or even be mounted on or near the doorknob assembly, powered from the doorknob assembly or from some other power source, e.g., a battery, inductive power, battery power, etc. FIG. 10 illustrates an exemplary motion/proximity sensor 941 disposed the housing 940 at or near the PCBA 938, though the position of the sensor 941 may vary.

In some examples, the door positioning system 100 includes a smarthome door lock, such as doorknob assembly 900. In some examples, a smarthome lock may be a device that can lock and unlock door locks using an app or program on a remote computing device and use a variety of different home network protocols including but not limited to ZigBee, Zwave, Bluetooth, and Wi-Fi. In some examples, the door positioning system 100, including the door lock, can be interfaced directly or via external communication hub (smarthome hub) with a smartlock to provide unique and novel functionality. In exemplary embodiments, the user can use a door positioning system to close a door then engage a smartlock, such as doorknob assembly 900, remotely. In some examples, with appropriately configured door hardware, such as but not limited to a non-manually latching doorknob or an electronically controlled latching doorknob, the door positioning system can be used to open a door that is unlocked via a smartlock. For example, the door positioning system would be used to disengage the smartlock, such as doorknob assembly 900, then the door positioning device would engage to open the door. Similarly, the door positioning system may include a smart doorknob that may be used in conjunction with the door positioning device. Alternately, a smartlock may be used in conjunction with other aspects described herein for locking and unlocking, without reliance on a door opening/closing/positioning system, the smartlock being configured as part of the hands-free system otherwise described herein.

In some examples, the smart doorknob provides a power-driven system to unlatch the doorknob. The latch is moved to the returned position by spring force. The smart doorknob may include a motor, circuitry, such as a PCBA electrically coupled to the motor and configured to be remotely connected to the remote computing device or activated by buttons on the smart doorknob itself. For example, when a signal is received by the smart doorknob, the motor may engage a power transmission assembly, such as a gear rack or similar power transmission elements that transform rotational motion and power into linear motion and power. This linear motion will retract the latch from the door jamb, in the disengaged latch position, and with the latch retracted, the door would be free swinging (providing for hands-free entry for a user).

The descriptions of the various aspects of the present invention have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects described herein.

Various aspects of the invention are described herein with reference to the related drawings. Alternative aspects of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of +8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, smart door systems.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A system for a hands-free entryway, comprising:
at least one sensor configured to sense a user that is approaching an entryway, the entryway comprising a door pivotally attached thereto;
a latch disengaging mechanism positioned in a jamb or frame of the entryway and controlled by a controller that is operatively associated with a processor, wherein the controller determines whether to activate the latch disengaging mechanism to automatically unlatch the door based on sensor data from the at least one sensor;
a user feedback component that indicates to the user that the entryway can be used without requiring hands to unlatch the entryway;
and an entryway closing device configured to bias the door of the entryway to a closed state.

2. The system of claim 1, wherein the entryway comprises a locking mechanism that includes a deadbolt, and wherein the sensor data includes deadbolt sensor status data relating to non-deployment or at least partial deployment of the deadbolt.

3. The system of claim 1, wherein the at least one sensor is positioned within at least one of the door, the jamb, or the frame of the entryway and detects any person approaching the entryway.

4. The system of claim 1, wherein the at least one sensor comprises one or more of a motion sensor, voice sensor, video sensor, mobile phone proximity sensor, ultra wide-band signal sensor, RFID tag, biometric sensor and camera configured with a pre-defined or user-definable sensing area.

5. The system of claim 1, wherein the at least one sensor is configured to detect at a predetermined height and distance relative to the entryway.

6. The system of claim 1, wherein the at least one sensor is configured to infer the user's intent to enter through the entryway.

7. The system of claim 1, wherein the at least one sensor is configured to authenticate a user using one or more authentication techniques from among biometric identification, mobile device authentication and behavioral analysis method.

8. The system of claim 7, wherein the biometric identification includes one or more of facial recognition with 3D depth mapping, voice pattern analysis, fingerprint scanning, and iris recognition.

9. The system of claim 1, wherein the at least one sensor comprises two or more different types of sensors, wherein each of the two or more different types of sensors senses a different type of authentication data, and wherein the processor is configured to integrate the different types of authentication data through a weighted algorithm to enforce specific entry conditions for different user types.

10. The system of claim 9, further comprising a management interface configured to receive input from an administrator for establishing the specific entry conditions for the different user types.

11. The system of claim 1, wherein the latch disengaging mechanism comprises an electric strike mechanism positioned within the jamb or frame of the entryway, and wherein the entryway closing device comprises at least one of a spring hinge, a pneumatic closer, a hydraulic closer, a rack-and-pinion closer, and an electric motor-driven closer.

12. The system of claim 1, wherein the user feedback component comprises one or more of a sound indicator and a light source.

13. The system of claim 12, wherein the light source positioned within the jamb or frame of the entryway that indicates, by emitting a light of a particular color, whether the entryway is operable for passage therethrough without requiring the user to manually unlatch the entryway.

14. The system of claim 1, further comprising a battery module separate from the user interface module positioned in the jamb or frame of the entryway.

15. The system of claim 1, further comprising a combined user interface module and battery module positioned within the jamb or frame of the entryway, wherein the combined user interface module and battery module houses both a power source and the user feedback component in a single housing.

16. A method for operating a hands-free entryway, comprising:
sensing, by at least one sensor, a user approaching an entryway, the entryway comprising a door pivotally attached thereto;
determining, by a controller operatively associated with a processor, whether to activate a latch disengaging mechanism positioned in a jamb or frame of the entryway to automatically unlatch the door based on sensor data from the at least one sensor;
providing, by a user feedback component, an indication to the user that the entryway can be used without requiring hands to unlatch the entryway; and
biasing, by an entryway closing device, the door of the entryway to a closed state.

17. The method of claim 16, wherein the entryway comprises a locking mechanism that includes a deadbolt, and wherein the sensor data includes deadbolt sensor status data relating to non-deployment or at least partial deployment of the deadbolt.

18. The method of claim 16, wherein the at least one sensor is positioned within at least one of the door, the jamb or the frame of the entryway and detects any person approaching the entryway.

19. The method of claim 16, wherein the at least one sensor comprises one or more of a motion sensor, voice sensor, video sensor, mobile phone proximity sensor, ultra wide-band signal sensor, RFID tag, biometric sensor and camera configured with a pre-defined or user-definable sensing area.

20. The method of claim 16, wherein sensing the user comprises detecting the user at a predetermined height and distance relative to the entryway.

21. The method of claim 16, further comprising inferring, by the at least one sensor, the user's intent to enter through the entryway.

22. The method of claim 16, further comprising authenticating, by the at least one sensor, a user using one or more authentication techniques from among biometric identification, mobile device authentication and behavioral analysis method.

23. The method of claim 22, wherein the biometric identification includes one or more of facial recognition with 3D depth mapping, voice pattern analysis, fingerprint scanning, or iris recognition.

24. The method of claim 16, wherein the at least one sensor comprises two or more different types of sensors, and further comprising:
sensing, by each of the two or more different types of sensors, a different type of authentication data; and
integrating, by the processor, the different types of authentication data through a weighted algorithm to enforce specific entry conditions for different user types.

25. The method of claim 24, further comprising receiving, by a management interface, input from an administrator for establishing the specific entry conditions for the different user types.

26. The method of claim 18, wherein the latch disengaging mechanism comprises an electric strike mechanism positioned within the jamb or frame of the entryway, and wherein the entryway closing device comprises at least one of a spring hinge, a pneumatic closer, a hydraulic closer, a rack-and-pinion closer and an electric motor-driven closer.

27. The method of claim 16, wherein providing the indication to the user comprises activating one or more of a sound indicator and a light source.

28. The method of claim 27, wherein providing the indication to the user comprises emitting, by the light source positioned in the jamb or frame of the entryway, a light of a particular color to indicate whether the entryway is operable for passage therethrough without requiring the user to manually unlatch the entryway.

29. The method of claim 16, further comprising powering the system using a battery module separate from the user interface module, wherein at least one of the battery module and the user interface module is positioned within the jamb or frame of the entryway.

30. The method of claim 16, further comprising housing both a power source and the user feedback component in a single combined module, the single combined module positioned within the jamb or frame of the entryway and further comprising the user interface module and a battery module.
